(19) United States
(12) Patent Application Publication
(10) Pub. No.: US 2017/0316419 A1
(43) Pub. Date: Nov. 2, 2017

(54) IMAGE ANALYSIS FOR LIVE HUMAN DETECTION

(71) Applicant: Giovanni Laporta, Watford (GB)

(72) Inventor: Giovanni Laporta, Watford (GB)

(21) Appl. No.: 15/584,075

(22) Filed: May 2, 2017

Related U.S. Application Data
(60) Provisional application No. 62/330,507, filed on May 2, 2016.

(51) Int. Cl. G06Q 20/40; G06F 21/32

(52) U.S. Cl. CPC G06Q 20/40145; G06F 21/32

(57) ABSTRACT

What is provided is a system, method, and article of manufacture for authenticating a mobile transaction by detecting a live person using biometric analysis. The method comprises entering user payment information into a server database, capturing at least one series of images of the user using a camera on the user's mobile computing device to measure light absorption from the illuminated skin surface or tissue of the user, analyzing the series of images to detect the presence and location of the illuminated skin surface or tissue of the first user, generating and extracting a PPG signal corresponding to the series of images, comparing the series of images from the PPG signal with predetermined values stored on the server, and displaying output data generated from the comparison of the PPG signal with the predetermined values to confirm the presence of a live human.

### PRIORITY CLAIM

This patent application is a Non-Provisional Patent Application and claims priority under 35 U.S.C. 119(e) to U.S. Provisional Patent Application Ser. No. 62/330,507, titled “IMAGE ANALYSIS FOR LIVE HUMAN DETECTION,” filed May 2, 2016. The entire disclosure of the aforementioned patent application is incorporated by reference as if fully stated herein.

### FIELD

This patent application relates to a system, method, and article of manufacture for authenticating mobile transactions through live human detection.

### BACKGROUND

Due to the increased presence of mobile computing devices, the risk of unauthorized access to software and databases becomes greater. Users may activate or gain access to functionalities controlled by a mobile computing device by opening or unlocking the device. In most instances, a mobile computing device may be configured to permit unlocking based on user authentication information. Authentication information may take various forms, including passcodes and biometric information. Examples of biometric information include photo capture, fingerprints, retina scans, motion sensing, touch control, and facial images. Facial images may be specifically authenticated using facial recognition technology. Many conventional front-facing cameras on mobile computing devices take facial images of the user in order to authenticate the face of the user. However, many of the current biometric solutions are unable to accurately distinguish between a real person and a photo or pre-recorded video of a real person.

Cameras on mobile computing devices have also been used to take facial images in order to measure vital signs, such as heart rate, of a user. The vital signs of a user were measured to serve as indicators of the current state of a user and as predictors of specific medical events. One way of measuring vital signs is through photoplethysmography (PPG). PPG generally refers to the measurement of volume changes of an organ or a body part and in particular to the detection of volume changes due to a user's heartbeat. PPG signals can be determined from a patient's skin using a camera. However, current methods for detecting a region of interest using PPG do not accurately and reliable account for the movement of a subject within the camera's field of view, which may lead to faulty measurements. Furthermore, current methods of using PPG and measuring a user's vital signs were not conducted for the live detection and verification of the user for the purposes of conducting and authenticating various mobile transactions.

Consequently, there is a need for a more reliable and accurate system and method for detecting the presence of a live human when performing a variety of functions and transactions through mobile computing devices. Further, it is highly desirable to detect the presence of a live human through his/her vital signs without the need to touch the mobile computing device or without the need for additional mobile computing devices.

### SUMMARY

What is provided is a system, method, and article of manufacture for authenticating a mobile transaction by detecting a live human using biometric analysis. Various biometric techniques may be used in the present invention, including but not limited generating and analyzing PPG signals taken from a user's body.

In exemplary embodiments, the system includes at least one user mobile computing device comprising an image sensor for capturing at least one image or video of the user's face, eyes, and/or skin; a light source used to measure the absorption of light in the user's tissue based on the intensity of light reflected from the user's skin surface and tissue; and a detection system. The detection system may comprise a second image sensor configured to receive light disbursed from the first user mobile computing device for generating a photoplethysmography (PPG) signal; a server configured to communicate with the first user mobile computing device and the second user mobile computing device, wherein the server comprises a database for storing information received from the first user mobile computing device and the second user mobile computing device; and an analysis unit for comparing and analyzing images and/or videos associated with the PPG signal and predetermined values stored in the database.

In another exemplary embodiment, the system may allow one or more users, such as a retailer user or a consumer user, to operate the secure article of manufacture through a user interface on the user's mobile computing device. In addition to managing and conducting mobile transactions, the article of manufacture may allow the user to securely authenticate and verify the transactions.

In yet another exemplary embodiment, personal information and data may be exchanges in real time between two users of the system through unique codes or identifiers. In addition to verifying the respective unique codes or identifiers, the system must authenticate each user using biometric techniques, such as PPG analysis.

In exemplary embodiments, the method for authenticating a mobile transaction by detecting the presence of a live human comprises entering payment information of a first user into a database of a server, wherein the server generates a unique identifier corresponding with the payment information; providing a light source to illuminate a skin surface or tissue on a body part of the first user; capturing at least one series of images of the first user using a camera on the first user's mobile computing device to measure light absorption from the illuminated skin surface or tissue of the first user; recording reflected light from the illuminated skin surface or tissue of the first user, wherein each color of the reflected light corresponds to a different wavelength of light; analyzing the series of images to detect the presence and location of the illuminated skin surface or tissue of the first user; generating and extracting a photoplethysmography (PPG) signal corresponding to the series of images; comparing the series of images from the PPG signal with predetermined values stored in a database on the server; displaying, on a second user's mobile computing device, output data generated from the comparison of the PPG signal with the predetermined values on the server; and confirming the presence of a live human prior to authenticating a mobile transaction.

### BRIEF DESCRIPTION OF THE DRAWINGS

Subject matter is particularly pointed out and distinctly claimed in the concluding portion of the specification. Claimed subject matter, however, as to structure, organization and method of operation, together with objects, features, and advantages thereof, may best be understood by reference to the following detailed description if read with the accompanying drawings in which:

FIG. 1 is a schematic view of an exemplary system for authenticating a mobile transaction by detecting a live human using image analysis;

FIG. 2 is a front view of an exemplary mobile computing device used with the system of FIG. 1;

FIG. 3 is a flow chart of an exemplary method for authenticating a mobile payment transaction on the at least one user mobile computing device by detecting the presence of a live human;

FIG. 4 is a flow chart of an exemplary method for authenticating a mobile transaction by verifying and detecting the presence of a live human through PPG;

FIG. 5 is a flow chart showing an exemplary method for completing one way personal identification and remote login of a user; and

FIG. 6 is flow chart of an exemplary method for exchanging personal information and data in real time between two users using mobile computing devices.

### DETAILED DESCRIPTION

In the following detailed description, numerous specific details are set forth in order to provide a thorough understanding of the examples as defined in the claimed subject matter, and as an example of how to make and use the examples described herein. However, it will be understood by those skilled in the art that claimed subject matter is not intended to be limited to such specific details, and may even be practiced without requiring such specific details. In other instances, well-known methods, procedures, and components have not been described in detail so as not to obscure the examples defined by the claimed subject matter.

Some portions of the detailed description that follow are presented in terms of algorithms and/or symbolic representations of operations on data bits and/or binary digital signals stored within a computing system, such as within a computer and/or computing system memory. An algorithm is here and generally considered to be a self-consistent sequence of operations and/or similar processing leading to a desired result. The operations and/or processing may take the form of electrical and/or magnetic signals configured to be stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer or a similar electronic computing device that manipulates and/or transforms data represented as physical electronic and/or magnetic quantities and/or other physical quantities within the computing platform's processors, memories, registers, and/or other information storage, transmission, and/or display devices.

Unless specifically stated otherwise, as apparent from the following discussion, it is appreciated that throughout this specification a computing platform includes, but is not limited to, a device such as a computer or a similar electronic computing device that manipulates and/or transforms data represented by physical, electronic, and/or magnetic quantities and/or other physical quantities within the computing platform's processors, memories, registers, and/or other information storage, transmission, reception and/or display devices. Accordingly, a computing platform refers to a system, a device, and/or a logical construct that includes the ability to process and/or store data in the form of signals. Thus, a computing platform, in this context, may comprise hardware, software, firmware and/or any combination thereof. Where it is described that a user instructs a computing platform to perform a certain action, it is understood that “instructs” may mean to direct or cause to perform a task as a result of a selection or action by a user. A user may, for example, instruct a computing platform embark upon a course of action via an indication of a selection, including, for example, pushing a key, clicking a mouse, maneuvering a pointer, touching a touch pad, touching a touch screen, acting out touch screen gesturing movements, maneuvering an electronic pen device over a screen, verbalizing voice commands, and/or by audible sounds. A user may include an end-user.

Flowcharts, also referred to as flow diagrams by some, are used in some figures herein to illustrate certain aspects of some examples. Logic they illustrate is not intended to be exhaustive of any, all, or even most possibilities. Their purpose is to help facilitate an understanding of this disclosure with regard to the particular matters disclosed herein. To this end, many well-known techniques and design choices are not repeated herein so as not to obscure the teachings of this disclosure.

Throughout this specification, the term “system” may, depending at least in part upon the particular context, be understood to include any method, process, apparatus, and/or other patentable subject matter that implements the subject matter disclosed herein. The subject matter described herein may be implemented in software, in combination with hardware and/or firmware. For example, the subject matter described herein may be implemented in software executed by a hardware processor.

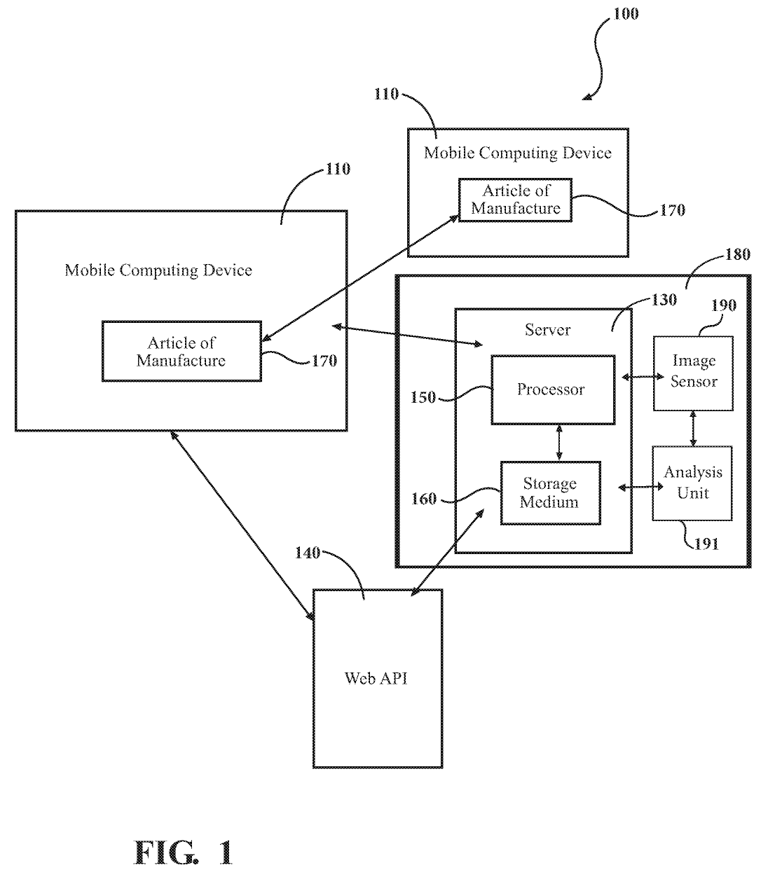

Referring to FIG. 1, FIG. 1 shows an exemplary system 100 for authenticating a mobile transaction by detecting the presence of a live human using image analysis. The system 100 includes at least one user mobile computing device 110, a web API 140, and a detection system 180. The detection system 180 comprises a server 130, an image sensor 190, and analysis unit 191. The server 130 may have a database 192, one or more processors 150, and a non-transitory storage medium 160 that may have instructions for communicating with the one or more processors 150. The non-transitory storage medium 160 can be fixed or removable. A service provider (not shown in FIG. 1) provides the secure web API 140 and makes available the instructions for managing the article of manufacture 170. The service provider may manage the activation of and any issues with the article of manufacture 170 associated with a user's account information. In some of the examples described herein, the service provider is known as UOO™.

In some embodiments, the image sensor 190 on the detection system 180 is configured to receive light disbursed from the mobile computing device 110 for generating a signal, such as PPG signal. The analysis unit 191 on the detection system 180 may be used to compare and analyze videos and/or images associated with the PPG and predetermined values stored on the database 192.

Each of the least one user mobile computing devices 110 may include an article of manufacture 170 allowing each of the at least one user mobile computing devices 110 to perform a variety of applications and transactions, such as, but not detecting a live human, signing an electronic document, swapping an image or video on a mobile computing device in real-time, and conducting online payment transactions. Although a smart phone is shown as an exemplary embodiment of the at least one user mobile computing device 110, the at least one user mobile computing device 110 is not limited to smart phones. Examples of the user mobile computing device 110 include, but are not limited to, a smartphone, smart watch, tablet personal computer, notebook computer, server computer, personal digital assistant, mobile device, handheld device, or any other functionally equivalent device known in the art.

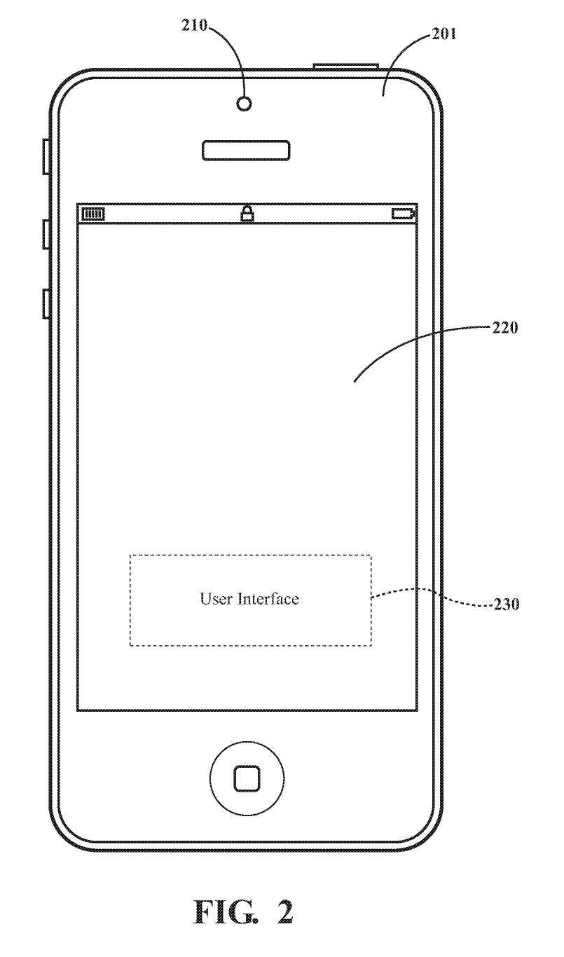

Referring to FIG. 2, FIG. 2 shows a front view of an exemplary user mobile computing device 110 used with the system 100 of FIG. 1. Although a smart phone 201 is shown as an exemplary embodiment of the at least one user mobile computing device 110, the user mobile computing device 110 is not limited to smart phones. Examples of the at least one mobile computing device 110 include, but are not limited to, a smartphone, a smart watch, a tablet personal computer, a notebook computer, a server computer, a personal digital assistant, a handheld device, or any other functionally equivalent mobile computing device known in the art.

The at least one user mobile computing device 110 includes an image sensor, such as camera 210, capable of capturing digital images and detecting whether the individual is a real human through an image and/or video. The camera 210 may be configured to capture videos and/or images of portions of the user's body, including the user's eyes and/or face while the user is using the mobile computing 110. The camera 210 may be integrated into the at least one user mobile computing device 110, such as a front-facing camera or a rear-facing camera and may be any type of camera, such as a digital camera with self-contained optics. In some embodiments, the camera 210 may be activated in order to begin video recording a blurred image of a user of the system 100. The blurred image may become de-blurred through the use of a filter configured to detect that a real human is using the system 100. Upon detection of a real human, the camera feed may open or complete an image capture through the at least one user mobile computing device 110.

The at least one user mobile computing device 110 also includes a display screen 220 that may receive input information from a user and provide visual information to the user through a user interface 230. In some embodiments, the user's payment instrument and information may be displayed when the user is making online payments. The user interface 230 may be several different operating systems, including Microsoft Windows®, Apple System 7®, and Mac OS X®. The display screen 220 and the user interface 230 may be used to present any user interface information regarding the systems, methods, and article of manufacture described with reference to FIGS. 1-6.

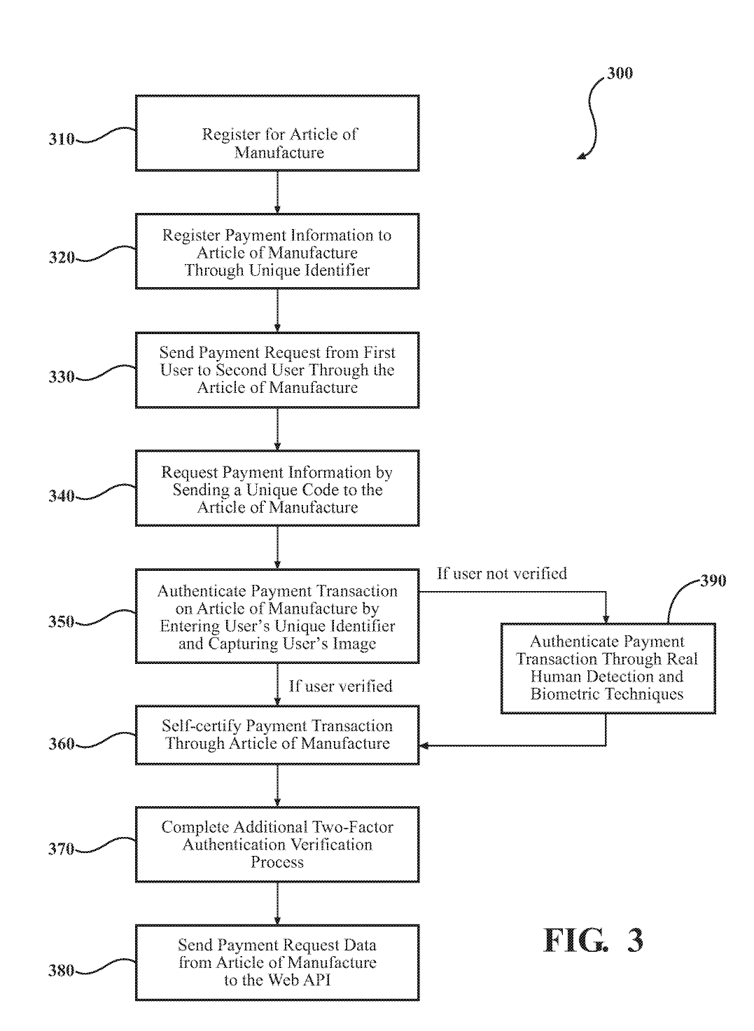

Referring to FIG. 3, FIG. 3 shows an exemplary method 300 for authenticating a mobile payment transaction on the at least one user mobile computing device 110 by detecting the presence of a live human. The method 300 is designed to provide a more convenient and secure method for preventing third parties from stealing the user's personal information and ensuring that the desired users are completing the online payment transactions. The communications involved in this embodiment are exchanged between multiple parties: a consumer user, a retailer user, and the service provider of the server 130 and the article of manufacture 170. In other embodiments, additional parties may also be involved in the mobile payment transaction and personal authentication method by performing various services, such as payment processing.

The method 300 may begin at block 310, where the user accesses the article of manufacture 170 and registers for its service by completing the necessary login information to create a secure account. In some of the examples described herein, the user may include additional data, such as the desired payment methods, social media information, or other data that may affect the performance or usability of the article of manufacture 170. The article of manufacture 170 may be available to download to the mobile computing device 110 via an “app store” or other functionally equivalent ways. The user stores his or her personal information, including debit and credit card information with the article of manufacture 170 and receives a personal identification number (PIN) and/or other unique identifier from the server 130. This data may be stored with varying levels of security on the server 130. The unique identifier provided to the user corresponds to a variety of predetermined tasks, such as, but not limited to conducting payment transactions, signing documents, and sharing images or videos in real-time via the user's mobile computing device 110. After the user enters the unique identifier into the article of manufacture 170 through the user interface 230, the article of manufacture 170 allows the user to access a customized, hidden interface; identifies the predetermined task(s) to be performed; and determines the specific authentication steps needed to be performed by the user to carry out the predetermined tasks.

At block 320, the user may register his or her credit and/or debit card information with the article of manufacture 170 by using his or her PIN and/or unique identifier. In some embodiments, the user's credit and/or debit cards may be registered by augmented reality software on the article of manufacture 170 of the user's mobile computing device 110. The user may take digital images of his or her credit and/or debit cards using the camera 210 on the mobile computing device 110 and incorporate the digital images into the article of manufacture 170 through the user interface 230. In addition to processing the user's payment information, the article of manufacture 170 simultaneously triggers the camera 210 on the mobile computing device 110 to capture a digital image and/or video of the user's face. During the registration process, the article of manufacture 170 may also request and process the user's post/zip code, which is linked to the user's payment instrument. In order to prevent duplicate payment card registration with the article of manufacture 170, payment cards are only registered once per user within the article of manufacture 170. The registration of credit and debit card information to the article of manufacture 170 may allow the user to make payments from any location in the world where the payment method is accepted.

At block 330, a user, such as a retailer user, may use his/her mobile computing device 110 and a unique identifier provided by the article of manufacture 170 to send a payment request to a unique identifier of a second user, such as a consumer user. The article of manufacture 170 displays information about the transaction to be completed by the consumer user, such as the goods or services to be purchased, the price of each, and the total price for the transaction. In some embodiments, the consumer user may use other methods of payment, such as pre-paid cards, gift cards, or coupons, on the article of manufacture 170 to complete a proposed transaction with the retailer user.

At block 340, online payments accepted by the article of manufacture 170 may only be requested when payment information is transmitted through the web API 140. In some of the examples described herein, the web API 140 is known as UOO™. The web API 140 may send a unique code or unique identifier to the article of manufacture 170 via wireless connection to communicate that the payment request is an online payment. In some of the examples described herein, the unique code or the unique identifier is known as UOO CODE™.

The user may then confirm and complete the payment transaction through the mobile computing device 110, as shown at block 350. In some examples, the user may employ the user interface 230 and the article of manufacture 170 to monitor each item on the bill, calculate a tip for the bill, enter an additional amount on the bill, such as a tip, and then pay the bill from the user's mobile computing device 110. In addition to entering the unique identifier on the user interface 230 of the mobile computing device 110 in order to allow the user access to a hidden interface on the article of manufacture 170, an image and/or videos of the user may be taken using the camera 210 of the user's mobile computing device 110. As a result, a real human face may be differentiated from an attempt to spoof the article of manufacture 170 using, for example, a photograph or pre-recorded video of the user's face in the front of the camera 210. If the user is verified as being a real person through the input of his/her unique identifier and the image of the user, the article of manufacture 170 may authenticate and complete the online payment transaction.

If the user is not verified as a real person using simply the photo/video capture option with the camera 210, other embodiments of real human detection may be used, such as voice and motion detectors, proximity sensors, focus sensors, ambient light sensors, augment reality analysis, glare and reflection detection, infrared (or other temperature) detection, and pulse detection, as shown at block 390. At least one second image or video of the user may be taken by the camera 210 of the user's mobile computing device 110 to capture additional biometric information, such as facial recognition information, retinal recognition information, movement detection information, voice recognition information, and/or light reflection information. In some embodiments, the article of manufacture 170 may analyze and record a reflected light signal of the user captured by the camera 210. In some embodiments, the article of manufacture 170 may cause a white, color, infrared light to flash from a light source on the display screen 220 of the user's mobile computing device 110. In alternative embodiments, the light source may be external from the user's mobile computing device 110. The article of manufacture 170 may record the reflected light (red, green, and/or blue) emitted from a user's skin, with each color corresponding to a different wavelength. The reflected light signal will result in a different light wavelength for a real human than from a pre-recorded video on an LCD screen. As a result, the article of manufacture 170 may use a combination of the embodiments disclosed herein to determine that a photo and/or video being taken for authentication is of a live, real person and not of a still photo or pre-recorded video.

In the voice and motion detection embodiment, the article of manufacture 170 looks for a facial gesture and/or a trigger word when the article of manufacture 170 randomly requests the user to say a specific word and/or make a specific facial gesture, such as a wink, or smile. If the predetermined value set by the article of manufacture 170 does not match the user's response, the article of manufacture 170 may determine that the photo being taken of the user is not of a real person and may not allow the authentication process to automatically capture or complete. In other words, the article of manufacture 170 matches the word stated by the user with the predetermined word provided to the user by the article of manufacture 170 and/or matches the facial gesture made by the user with the predetermined facial gesture provided to the user by the article of manufacture 170.

In the proximity sensor embodiment, the article of manufacture 170 is used for measuring the distance between the front of the user's mobile computing device 110 and an object when taking a photo for authentication of a user. If the distance does not fall into the predetermined value set by the article of manufacture 170, the article of manufacture 170 may determine that the photo being taken of the user is not of a real person and may not allow the authentication process to auto capture or complete. The proximity value may be determined by a number of factors, such as the object's features and the distance of the object.

In the focus sensor embodiment, the article of manufacture 170 is used for measuring depth of foreground and background together with facial features to determine the difference between the 3-dimensional and 2-dimensional depth when taking a photo. If the focus does not fall into the predetermined value set by the article of manufacture 170, the article of manufacture 170 may determine that the photo being taken of the user is not of a real person and may not allow the authentication process to auto capture or complete.

In the ambient light sensor embodiment, the article of manufacture 170 is used for measuring light emitted from the LCD backlight that may be placed in front of it, such as backlight from a TV, computer screen, or another mobile device when taking a photo. If the article of manufacture 170 detects a light emitting device in front of the mobile computing device 110 when taking an authentication photo, the article of manufacture 170 will determine the light is false and being taken of the user is not of a real person and may not allow the authentication process to auto capture or complete.

In the augmented reality embodiment, the article of manufacture 170 is used for measuring recognized image layers and depth set by the article of manufacture 170 when analyzing captured images taken by the camera 210. In order to accurately measure depth, the user may be asked by the article of manufacture 170 to move closer or further away from the camera 210, while the background remains still. If the article of manufacture 170 determines that the user is not a real person, the article of manufacture 170 will prevent the authentication process from auto capturing additional images and completing.

In the glare and reflection detection embodiment, the camera software in the article of manufacture 170 is used for measuring the glare or reflection emitted by other electronic devices in front of the user mobile computing device 110. If the article of manufacture 170 detects there is such a device in front of the user mobile computing device 110 when taking an authentication photo, the article of manufacture 170 will determine that the user is not a real person and may not allow the authentication process to auto capture or complete.

In some embodiments, if the user is not verified as a real person using the authentication methods provided above, the article of manufacture 170 triggers a real person to intercept the proposed transaction and assist with the completion of the authentication process. The real person serves as an authorized technical representative of the service provider. This optional step is meant to limit any user difficulties navigating through the system 100 and/or any malfunctions or errors with the system 100.

At block 360, the article of manufacture 170 may provide for a self-certification process, where the article of manufacture 170 may not become active for online payments until the consumer user has made at least five (5) individual payments to at least five (5) different retailer users using the same article of manufacture 170 through the consumer user's unique identifier. The at least five individual payments must be by the consumer user in the real world retail sector. The more that a consumer user uses the article of manufacture 170 for conducting payment transactions, the more secure the article of manufacture 170 becomes. In some embodiments, about five different payments to about five different retailer users using the same article of manufacture 170, the article of manufacture 170 may establish that the consumer user is a real human, the photos are accurate representations of the consumer users, and that the registered payment cards are legitimate.

At block 370, the article of manufacture 170 may complete a two-factor authentication process for the online payments, where the first factor is confirming the validation of an authentic code or unique identifier that the user has specifically entered into the article of manufacture 170 and the second factor is verifying that the user has completed the article of manufacture 170 self-certification program. In another embodiment, the article of manufacture 170 may also verify the specific geolocation of the user. The article of manufacture 170 may identify the user's location and upload the location, along with a photo of the user, and the user's unique identifier to the user's mobile computing device 110. When a consumer user pays through online payment transactions, there are significant advantages of uploading the user's location to the user interface 230, instead of simply relying on NFC or (POS) terminals.

At block 380, once the user has been successfully verified, the article of manufacture 170 on the user's mobile computing device 110 sends the payment request data securely over HTTPS to the web API 140 for payment processing. The web API 140 receives the payment data and passes this information forward to a payment processor. In some of the examples described herein, the payment is processed by the service provider's web API 140. In other examples, the payment processing may involve the use of third-party payment processors.

In some embodiments, the article of manufacture 170 may allow users to exchange personal information and data with businesses, without this personal data ever being mentioned out loud. The system 100, using the article of manufacture 170, may complete the check by using the information and data found on the servers of respective business and in the respective user's profile. In one embodiment, the user profile may be known as a UOO DATA PROTECTION PROFILE™. The check will be completed if the system 100 determines that the data matches and the parties will continue to engage in their business. There are several applications of the data protection check process mentioned above.

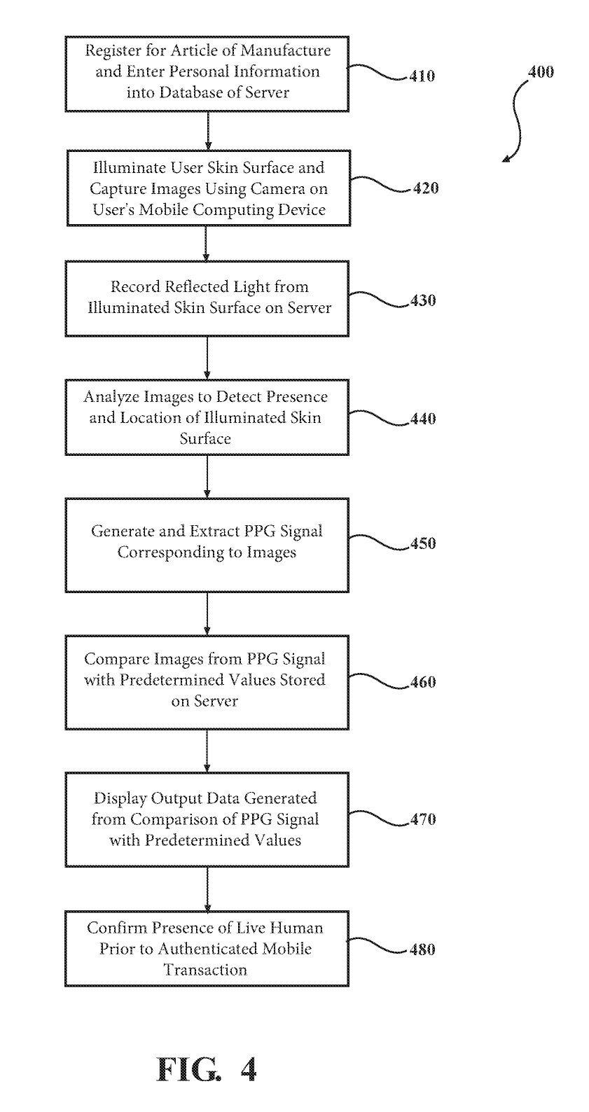

Referring to FIG. 4, FIG. 4 shows an exemplary method 400 for authenticating a mobile transaction by verifying and detecting the presence of a live human through PPG. At block 410, a user accesses the article of manufacture 170 and registers for its service by completing the necessary login information to create a secure account. In some of the examples described herein, the user may include additional data, such as the desired payment methods, social media information, or other data that may affect the performance or usability of the article of manufacture 170. The article of manufacture 170 may be available to download to the mobile computing device 110 via an “app store” or other functionally equivalent ways.

The user stores his or her personal information, including debit and credit card information with the article of manufacture 170 and receives a personal identification number (PIN) and/or other unique identifier from the server 130. This data may be stored with varying levels of security on the database 192. The unique identifier provided to the user corresponds to a variety of predetermined tasks, such as, but not limited to conducting payment transactions, signing documents, and sharing images or videos in real-time via the user's mobile computing device 110. After the user enters the unique identifier into the article of manufacture 170 through the user interface 230, the article of manufacture 170 allows the user to access a customized, hidden interface; identifies the predetermined task(s) to be performed; and determines the specific authentication steps needed to be performed by the user to carry out the predetermined tasks.

At block 420, a light source, such as a light emitting diode (LED), may be used to illuminate a skin surface and/or a blood-perfused tissue on the user. The image sensor may be used to measure the absorption of light in the user's tissue based on the intensity of light reflected from the user's skin. The intensity of light received by the sensor varies according to the change in blood volume in the user's skin and related light absorption. The body part may be a face, forehead, finger, or the like. Specifically, the system 100 can flash a white, color, or infrared light from a light source on the at least one user mobile computing device 110. In other embodiments, the system 100 can flash a white, color, or infrared light through an external light source, such as a pulse oximeter. The system 100 can record the reflected light (red, green, and/or blue) from a user's living skin, with each color corresponding to a different wavelength of light.

The article of manufacture 170 then triggers the camera 210 to capture video/picture input of a user's body part in order to generate and/or acquire a plethysmographic waveform. The camera may capture a series of images of a user in order to measure light absorption from the illuminated skin surface or tissue of the first user. In some embodiments, the camera 210 may be activated in order to begin video recording a blurred image of the user of the system 100. The blurred image may become de-blurred through the use of a filter configured to detect that a real human is using the system 100. The system 100 may request that the user moves his face closer or further away from the camera 210 to ease with obtaining a 3-Dimensional measurement on a fixed background. The camera 210 adjusts the focal length for capturing the images from different depths of the field. In some embodiments, the camera 210 may capture a series of images of the body part as video frames.

At block 430, the server 130 then records the reflected light from the illuminated skin surface of the user. Specifically, the reflected light is stored in the database 192. The processors 150 in the server 130 then process the series of captured images to detect the presence and location of the user's body part by analyzing the brightness variation of the images, as shown in block 440. The processing may involve identifying a region of interest within the series of images, separating each of the series of images and averaging the pixels within the region of interest. A signal, such as the plethysmographic waveform, may then be extracted through a series of filtering steps.

At block 450, the image sensor 190 in the detection system 180 receives the light disbursed from the user mobile computing device 110 and generates and extracts a PPG signal corresponding to the captured images of the user. The analysis unit 191 then compares images from the PPG signal with predetermined values stored on the database 192, as shown in block 460. This comparison is made in the detection system 180 in order to distinguish between pre-recorded videos footage/pictures and live videos/images of real humans. Some of the specific features that are measured and compared with predetermined values include the absorption and reflection of skin color from the user. According to predetermined values and matching scores stored on the database 192, the article of manufacture 170 may determine that the image is of a live human, as opposed to an attempt to spoof the system 100. In this embodiment, the predetermined values correspond to user data previously obtained from at least one real human.

At block 470, the article of manufacture 170 may display, on a second user's mobile computing device 110, the output data generated from the comparison of the PPG signal with the predetermined values on the server 130. The second user may then analyze the output to readily determine whether the other party is a live human prior to the system 100 authenticating a mobile transaction, as shown in block 480. In some embodiments, the image of the first user may be cross-referenced with at least one additional biometric step, such as facial, voice, and/or finger print analysis, to provide additional layers of verification and security. In a particular embodiment, the system cross-references the image with a random word generated by the system and spoken by the user as the system captures the video footage of the user's voice.

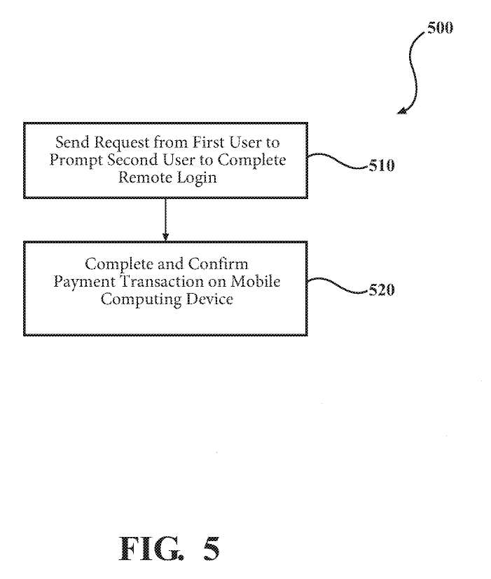

Referring to FIG. 5, FIG. 5 shows an exemplary method 500 for completing one way personal identification and remote login of a user. At block 510, online websites may send a request to the article of manufacture 170 through a user's unique identifier prompting the user to complete a remote login. A user may complete the login process using his mobile computing device 110 through the same authentication process used in the online payment embodiments disclosed above, as shown in 520. Some of the applications of this exemplary embodiment include door and turnstile entry systems. In certain examples described herein, the authentication process from FIG. 3 may also be used in this embodiment. In some of the examples described herein, this method 500 is known as UOO PASS™.

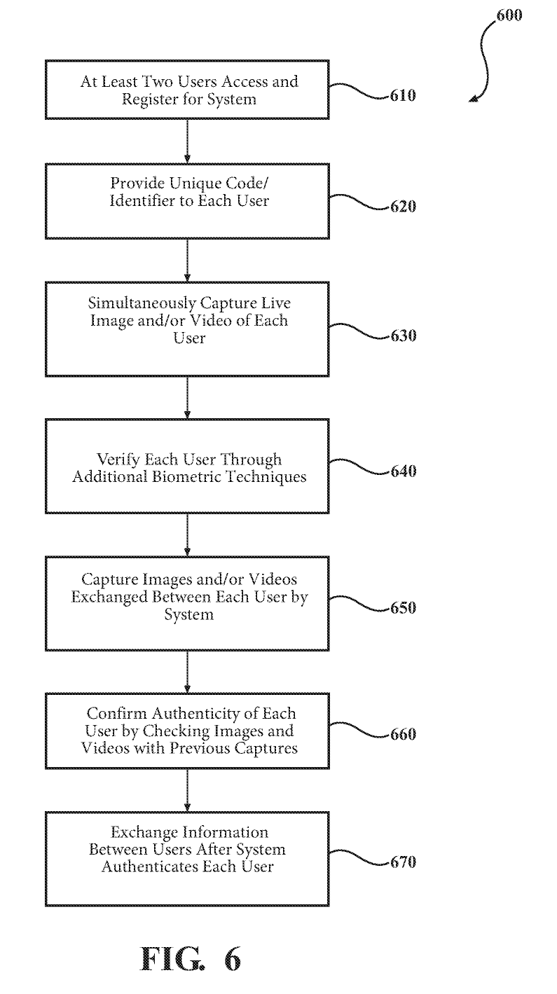

Referring to FIG. 6, FIG. 6 shows a flow chart of an exemplary method 600 for exchanging personal information and data in real time between two users using mobile computing devices. In some embodiments, the content may be images, text, and/or videos. At least two users are required to securely exchange or “swap” content. At block 610, at least two users access the article of manufacture 170 and register for its service by completing the necessary login information to create secure account. At block 620, each user is provided with a unique code or identifier from the web API 140 of the system 100. After exchanging/swapping their respective unique codes or identifiers, each user can enter the other user's unique code or identifier on each user's respective user interface 230 when prompted to do so by the system 100. The system 100 then simultaneously captures a live image and/or video of each of the participating users as disclosed above, at block 630.

At block 640, in some embodiments, the system 100 may require an additional level of biometric security prior to allowing the exchange of information between the two users. Specifically, the system 100 may generate a random word for each user to say at the same time that picture is captured and/or video recorded. Additionally, or as an alternative to the voice recognition step, the system 100 may require each user moves his/her face closer or further away from the camera 210 to ease with obtaining a 3-Dimensional measurement on a fixed background. These additional biometric steps provide additional layers of verification to ensure that a live human is begin recorded.

Next, at block 650, the system 100 exchanges the captured images and/or recordings with each user and verifies that each captured voice recording is of a real person, if a user's voice was recorded. At block 660, the system 100 can cross-check the exchanged images and videos with previous image and video captures of the user to confirm authenticity. Once approved, the users can begin exchanging information and data between each other, as shown at block 670. In some of the examples described herein, this method 600 is known as UOO SWAP™.

Other applications of the method 600 disclosed above include allowing users to check into a function, meeting, or similar event using the unique code or identifier that is specific for the event. In one embodiment, this process is known as CROWD SWAP™. This method may service as a substitute to exchanging business cards. This process may also allow users to check-in at a bar or restaurant using the unique code or identifier in order to connect at a specific location with other users. Once at least two users are connected to the system 100 using the same unique code or identifier, they can exchange personal information and data with one another, such as marital status, dating preferences, and hobbies.

The unique code or identifier can also allow the system 100 to rely on live human detection to complete delivery of printed letters and parcels. Specifically, the system 100 and live human detection methods disclosed herein can allow users to readily sign for letters and parcels through any location. Further, a unique code or identifier can allow users to enter website or building securely and safely. In some embodiments, this method is known as UOO DELIVERY™.

In yet another embodiment, a user may send business and personal documents to another user through the article of manufacture 170 for approval, review, and/or execution. The user may review, approve, and electronically sign documents. The delivery address of the user may be authenticated upon sending of the documents. In certain examples described herein, the authentication process from FIG. 3 may also be used in this embodiment. In some of the examples described herein, this method is known as UOO SIGN™.

In addition to the foregoing, various aspects or features described herein can be implemented as a method, system, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally, various storage media described herein can represent one or more devices and/or other machine-readable media for storing information.

The article of manufacture that may be used with the systems and methods described herein according to one or more examples, although the scope of claimed subject matter is not limited in this respect. The article of manufacture may include more and/or fewer components than those discussed herein; however, generally conventional components may not be shown. The article of manufacture may be used to employ tangibly all or a portion of FIGS. 1-6, and/or other processes disclosed herein.

It will, of course, be understood that, although particular embodiments have just been described, the claimed subject matter is not limited in scope to a particular embodiment or implementation. Likewise, an embodiment may be implemented in any combination of systems, methods, or products made by a process, for example.

In the preceding description, various aspects of claimed subject have been described. For purposes of explanation, specific numbers, systems, and/or configurations were set forth to provide a thorough understanding of claimed subject matter. Computer file types and languages, and operating system examples have been used for purposes of illustrating a particular example. However, it should be apparent to one skilled in the art having the benefit of this disclosure that claimed subject matter may be practiced with many other computer languages, operating systems, file types, and without these specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that claims are intended to cover all such modifications or changes as fall within the true spirit of claimed subject matter.

1. A computer-implemented method for authenticating a mobile transaction by detecting the presence of a live human, the method comprising:
entering personal information of a first user into a database of a server, wherein the server generates a unique identifier corresponding with the personal information;
providing a light source to illuminate a skin surface or tissue on a body part of the first user;
capturing at least one series of images of the first user using a camera on the first user's mobile computing device to measure light absorption from the illuminated skin surface or tissue of the first user;
recording reflected light from the illuminated skin surface or tissue of the first user, wherein each color of the reflected light corresponds to a different wavelength of light;
analyzing the series of images to detect the presence and location of the illuminated skin surface or tissue of the first user;
generating and extracting a photoplethysmography (PPG) signal corresponding to the series of images;
comparing the series of images from the PPG signal with predetermined values stored in a database on the server;
displaying, on a second user's mobile computing device, output data generated from the comparison of the PPG signal with the predetermined values on the server; and
confirming the presence of a live human prior to authenticating a mobile transaction.

2. The computer-implemented method of claim 1, wherein the light source is an infrared light emitting diode, a red light emitting diode, a blue light emitting diode, or a green light emitting diode.

3. The computer-implemented method of claim 1, wherein the body part is a face, a forehead, or a finger.

4. The computer-implemented method of claim 1, wherein the personal information comprises payment information.

5. The computer-implemented method of claim 1, wherein the predetermined values correspond to user data previously obtained from at least one real human.

6. The computer-implemented method of claim 5, wherein the output data provides an indication of whether the first user is a live human.

7. The computer-implemented method of claim 1, the method further comprising capturing at least one video of the first user using a camera on the first user's mobile computing device.

8. The computer-implemented method of claim 7, the method further comprising extracting biometric information from the video of the first user.

9. The computer-implemented method of claim 8, wherein the biometric information comprises light reflection information, retinal recognition information, movement detection information, voice recognition information, or fingerprint information.

10. The computer-implemented method of claim 9, wherein the voice recognition information comprises a randomly selected word that the first user is requested to speak.

11. A system for authenticating a mobile transaction by detecting the presence of a live human, the system comprising:
a first user mobile computing device comprising a first image sensor configured to capture images or videos of the first user to generate image or video signals;
a second user mobile computing device comprising a display screen configured to provide visual information to a second user through a user interface;
a light source configured to provide light of different wavelengths to illuminate a skin surface or tissue of the first user;
a detection system comprising:
a second image sensor configured to receive light disbursed from the first user mobile computing device for generating a photoplethysmography (PPG) signal;
a server configured to communicate with the first user mobile computing device and the second user mobile computing device, wherein the server comprises a database for storing information received from the first user mobile computing device and the second user mobile computing device; and
an analysis unit for comparing and analyzing images and/or videos associated with the PPG signal and predetermined values stored in the database.

12. The system of claim 11, wherein the first image sensor is a camera.

13. The system of claim 11, wherein the light source is an infrared light emitting diode, a red light emitting diode, a blue light emitting diode, or a green light emitting diode.

14. The system of claim 11, wherein the predetermined values correspond to user data previously obtained from at least one real human.

15. The system of claim 14, wherein the server is further configured to generate output data to the second user's mobile computing device based on the comparison of the PPG signal with the predetermined values stored on the database.

16. The system of claim 15, wherein the output data provides an indication of whether the first user is a live human.

17. The system of claim 16, wherein the presence of a live human is confirmed prior to the detection system authenticating a mobile transaction.

18. The system of claim 11, wherein the detection system is configured to extract additional biometric information from the images or videos of the first user.

19. The system of claim 18, wherein the biometric information comprises retinal recognition information, movement detection information, voice recognition information, or fingerprint information.

20. The system of claim 19, wherein the voice recognition information comprises a randomly generated word by the detection system that the first user is requested to speak.
